(19) United States
(12) Patent Application Publication
(10) Pub. No.: US 2015/0267927 A1
(43) Pub. Date: Sep. 24, 2015

(54) COLLAPSIBLE AIR FILTER ASSEMBLY

(71) Applicant: 3M INNOVATIVE PROPERTIES COMPANY, St. Paul, MN (US)

(72) Inventors: Zhiqun Zhang, Roseville, MN (US); Nicholas A. Echeverri, Woodbury, MN (US); Andrew R. Fox, Oakdale, MN (US)

(21) Appl. No.: 14/664,069

(22) Filed: Mar. 20, 2015

Related U.S. Application Data
(60) Provisional application No. 61/968,949, filed on Mar. 21, 2014.

(51) Int. Cl. F24F 3/16; B01D 46/52; B01D 46/00

(52) U.S. Cl. CPC F24F 3/1603; B01D 46/0005; B01D 46/521

(57) ABSTRACT

The present disclosure relates generally to air filter systems and air filters. More particularly, it relates to air filter systems capable of transitioning from a collapsed arrangement to an expanded arrangement.

### TECHNICAL FIELD

The present disclosure relates generally to air filter systems and air filters. More particularly, it relates to air filter systems capable of transitioning from a collapsed arrangement to an expanded arrangement.

### BACKGROUND

Disposable air filters are commonly used in forced air systems (e.g., residential heating and air-conditioning systems often referred to as “HVAC” systems) to remove particulate matter (e.g., dust and dirt particles). Air filters typically include a filter media surrounded and supported by a frame. Additional supporting and/or reinforcing components, such as a mesh screen and/or adhesive beads, may also be included. After a period of use, the filter media becomes dirty or clogged, and must be replaced. This is accomplished by replacing the entire air filter system. Even though only the filter media portion of the air filter system is no longer functional, the entire air filter system is discarded, resulting in waste.

In addition to supporting the filter media, the frame defines a perimeter size and shape of the air filter, and is normally selected to match the size and shape of the expected end-use application. For example, many residential HVAC systems are configured for use with a “standard” sized air filter of 20″×20″×1″ or 20″×25″×1″. The rigid frame dictates that the air filter has this rather large size when shipped to a retailer, when presented to potential purchasers, and when stored by an end user. Consequently, these air filters undesirably occupy a relative large volume of space on transportation vehicles, on retailer shelves, and in end user's homes.

### SUMMARY

The inventors of the present disclosure recognized the benefits of having a collapsible and/or extendible air filter assembly that overcomes one or more of the above-mentioned problems associated with conventional, disposable air filters. Some air filter assembly embodiments of the present disclosure include reusable portions such that only a portion of the entire air filter system needs to be disposed of after use. For example, in some embodiments, only the filter media is disposed of after a single use. Some air filter assembly embodiments of the present disclosure have a significantly decreased size during at least one of transport, sale, and/or storage. For example, in some embodiments, the air filter system (or portions thereof) is folded into less than 1/2 of its original size.

Some embodiments relate to an HVAC air filter, comprising: a frame having first and second end frame members and first and second side frame members; and filter media extending between and attached to the first and second end frame members or the first and second side frame members but not attached to the other of the first and second end frame members or the first and second side frame members; wherein the frame is a two-piece frame that is attached to the filter media. In some embodiments, the filter media includes pleats. In some embodiments, the first and second side frame members are respectively coupled to the first and second end frame members to form the two-piece frame. In some embodiments, the first and second side frame members are respectively coupled to the first and second end frame members via a hinge. In some embodiments, the air filter is configured to provide a collapsed state in which the filter media is compacted, and an expanded state in which the filter media is stretched, a distance between the first and second end frame members in the collapsed state is less than the length between the first and second end frame members in the expanded state. In some embodiments, the side frame members are transitionable to an arrangement that retains the air filter in the expanded state. In some embodiments, the air filter further includes a closure. In some embodiments, the air filter further includes one or more components or bodies that are slidable relative to one another in a telescoping-like fashion and that can be attached to at least one of (1) the first or second end frame members or (2) the first or second side frame members. In some embodiments, at least one of the first and second side frame members can be attached to the filter media.

Some embodiments relate to an HVAC air filter, comprising: a frame having first and second end frame members and first and second side frame members; and filter media extending between and attached to the first and second end frame members or the first and second side frame members but not attached to the other of the first and second end frame members or the first and second side frame members; wherein the frame is a one-piece frame at least a portion of which is attached to the filter media. As used herein, the term “one-piece frame” refers to an air filter assembly that is capable of forming a complete 4-sided frame but may include more than 1 piece as long as all pieces of the frame are connected and/or form a single system.

In some embodiments, the filter media includes pleats. In some embodiments, the filter media includes opposing sides and opposing ends, and first and second end frame members are assembled to a corresponding one of the opposing ends; wherein first and second side frame members are selectively coupled to the end frame members and over a respective one of the opposing sides. In some embodiments, the air filter is configured to provide a collapsed state in which the pleats are compacted, and an expanded state in which the pleats are stretched, the length in the collapsed state is less than the length in the expanded state. In some embodiments, the side frame members are transitionable to an arrangement that retains the air filter in the expanded state. In some embodiments, the air filter includes a first section pivotably coupled to the first frame end member at a first pivot point; a second section pivotably coupled to the second end frame member at a second pivot point; and the first and second sections pivotably coupled to each other at a third pivot point.

Some embodiments relate to an HVAC air filter comprising: a pleated filter medium assembly defining pleats, opposing sides and opposing ends; first and second end frame members assembled to a corresponding one of the opposing ends; and first and second side frame members selectively coupled to the end frame members and over a respective one of the opposing sides; wherein a distance between the end members define a length of the air filter; and further wherein the air filter is configured to provide a collapsed state in which the pleats of the pleated filter medium assembly are compacted, and an expanded state in which the pleats are stretched, the length in the collapsed state being less than the length in the expanded state, the side frame members being transitionable to an arrangement that retains the air filter in the expanded state.

### BRIEF DESCRIPTION OF THE DRAWINGS

FIG. 1A is a perspective view of an air filter in accordance with principles of the present disclosure and arranged in a collapsed state;

FIG. 1B is a perspective view of the air filter of FIG. 1A transitioning to an expanded state;

FIG. 1C is a perspective view of the air filter of FIG. 1A in an expanded state;

FIG. 2A is a perspective view a pleated filter media assembly useful with air filters of the present disclosure and in an expanded condition;

FIG. 2B is a cross-sectional view of the pleated filter media assembly of FIG. 2A, taken along the line 2B-2B;

FIG. 2C is a side view of a portion of the pleated filter media assembly of FIG. 2A in a collapsed condition;

FIG. 3A is a simplified perspective view of another air filter in accordance with principles of the present disclosure and arranged in a collapsed state;

FIG. 3B is a perspective view of the air filter of FIG. 3A transitioning to an expanded state;

FIG. 3C is a perspective view of the air filter of FIG. 3A in an expanded state;

FIG. 4A is a simplified perspective view of another air filter in accordance with principles of the present disclosure and arranged in a collapsed state;

FIG. 4B is a perspective view of the air filter of FIG. 4A transitioning to an expanded state;

FIG. 4C is a perspective view of the air filter of FIG. 4A in an expanded state;

FIG. 5A is a simplified perspective view of another air filter in accordance with principles of the present disclosure and arranged in a collapsed state;

FIG. 5B is a perspective view of the air filter of FIG. 5A transitioning to an expanded state;

FIG. 5C is a perspective view of the air filter of FIG. 5A in an expanded state; and

FIGS. 6A-6C are simplified end views of the air filter of FIG. 5C and illustrating assembly of a side frame element about a filter frame media assembly.

### DETAILED DESCRIPTION

Some air filter and/or air filter system embodiments of the present disclosure relate generally to at least a portion of the air filter assembly being configured to transition between a collapsed state and an expanded state. The air filter can be shipped and stored when in a collapsed state, permitting decreased transport and storage space and/or fees. When in use, the air filter is typically in its expanded state.

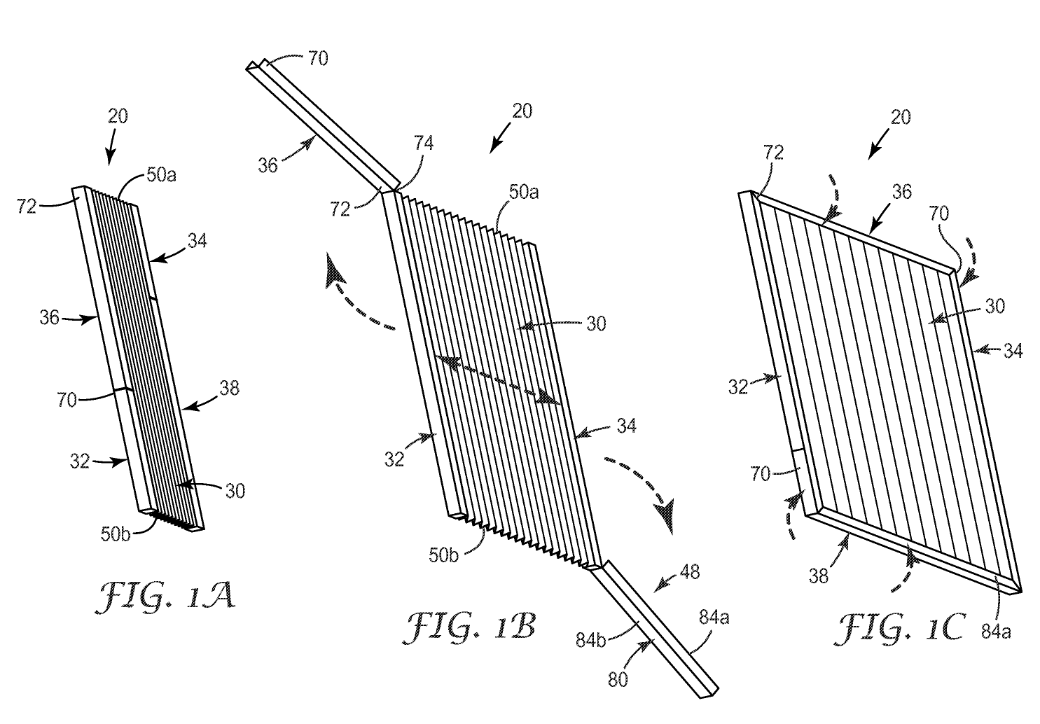

One embodiment of an air filter 20 in accordance with principles of the present disclosure is shown in FIGS. 1A-1C. The air filter 20 is generally configured to be expandable by a user from a collapsed, initial state (FIG. 1A) to an expanded, end-use state (FIG. 1C), and to self-retain the expanded state for installation and use within an HVAC system. The air filter 20 includes a pleated filter media assembly 30, opposing first and second end frame members 32, 34, and first and second side frame member 36, 38. Details on the various components are provided below. In general terms, the pleated filter media assembly 30 is configured to readily transition between the collapsed and expanded states by directing the end frame members 32, 34 toward or away from each other. Upon transitioning the pleated filter media assembly 30 to a desired size or length in the expanded state, the side frame member 36, 38 are manipulated to robustly secure the pleated filter media assembly 30 in the selected expanded state. In some embodiments, a removable wrapper or other packaging can be provided to retain the air filter 20 in the collapsed state (with the air filter 20 and the packaging combining to define a packaged air filter for retail sale). With these optional constructions, the packaging can be removed to permit transitioning of the air filter 20 to the expanded state. Regardless, the air filter 20 does not require a conventional, rigid frame permanently surrounding the pleated filter media assembly 30, and can be provided in the collapsed state to save space with shipping and display.

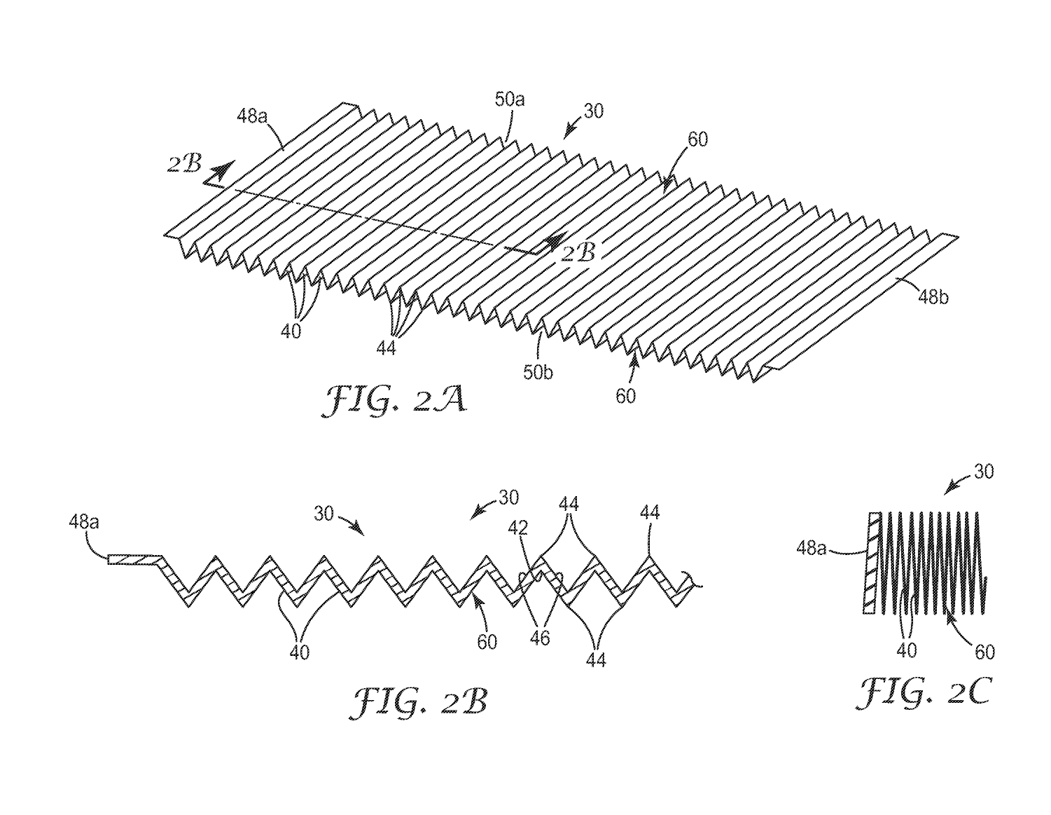

The pleated filter media assembly 30 can assume a wide variety of forms useful for HVAC air filtration presently known, or in the future developed. By “pleated” is meant a web at least a portion of which has been folded to form a configuration comprising rows of generally parallel, oppositely oriented folds. For example, and as shown in FIGS. 2A and 2B, the pleated filter media assembly 30 includes a plurality of pleats 40 each including a fold line 42 defining a pleat tip 44 and a pair of adjacent panels 46. Materials and construction of the pleated filter media assembly 30 are such that the pleated filter media assembly 30 can, in some embodiments, be repeatedly transitioned between an expanded condition as in FIG. 2B and a collapsed condition as in FIG. 2C, with a spacing distance between successive pleat tips 44 in the expanded condition being greater than that of the collapsed condition. As a point of reference, the “expanded condition” of the pleated filter media assembly 30 as an individual component generally corresponds with the “expanded state” of the air filter 20 (FIG. 1C) as a whole (and the “collapsed condition” of the pleated filter media assembly 30 generally corresponds with the “collapsed state” of the pleated air filter 20 (FIG. 1A)), except that the air filter 20 includes additional components (described below) that retain the pleated filter media assembly 30 in the particular size and shape of the expanded state. In other words, while the pleated filter media assembly 30 can be transitioned (e.g., stretched or compacted) to any of a number of different “expanded conditions” and “collapsed conditions”, the pleated filter media assembly 30 cannot, in and of itself, self-retain the shape of any one particular condition. The air filter 20, however, as whole can self-retain the shape of the selected expanded state and collapsed state. The pleated filter media assembly 30 can have the rectangular shape (that is specifically inclusive of a square shape) shown, defining opposing ends 48a, 48b and opposing sides 50a, 50b.

The pleated filter media assembly 30 can consist of a pleated filter media or web 60 alone (as in the illustrated embodiment), or can include one or more additional components or structures applied or assembled to a pleated filter media 60 so long as the resultant pleated filter media assembly 30 can at least be transitioned from the collapsed condition to the expanded condition without damaging a structural integrity of the pleated filter media assembly 30, and optionally can be repeatedly transitioned between the collapsed and expanded conditions without damaging a structural integrity of the pleated filter media assembly 30. The pleated filter media 60 of the assembly 30 can be self-supporting or non-self-supporting. For example, where the pleated filter media assembly 30 consists of the pleated filter media 60 alone, the pleated filter media or web 60 can be self-supporting or non-self-supporting. Where the pleated filter media assembly 30 consists of the pleated filter media or web 60 and a support structure, the pleated filter media 60 can be non-self-supporting with the addition supporting structure rendering the pleated filter media assembly 30, as a whole, to be self-supporting. A “self-supporting pleated filter media or web” can describe a pleated filter media or web that is deformation resistant without requiring stiffening layers, adhesive or other reinforcement in the filter media web. Alternatively, “self-supporting” means that the pleated filter media generally maintains its shape when subjected to an airstream as described, for example, in U.S. Patent No. 7,169,202 to Kubokawa, the entire teachings of which are incorporated herein by reference. Alternatively, the term “self-supporting” refers to a web or media having sufficient coherency and strength so as to be drapable and handleable without substantial tearing or rupture, and when used with respect to a pleated filter refers to a filter whose pleats have sufficient stiffness so that they do not collapse or bow excessively when subjected to the air pressure typically encountered in force air ventilation systems. The term “non-self-supporting” can denote an air filter media that is not capable, in the absence of a support frame and/or a support grill, of withstanding the forces encountered due to forced air flow in a typical residential HVAC system when placed in a conventional holding fixture of the typical residential HVAC system.

The particular filter media 60 selected for the pleated filter media assembly 30 is not critical to the present disclosure so long as the resultant pleated filter media assembly 30 (whether consisting solely of the pleated filter media 60 alone or with additional structures applied thereto) has the desired characteristics described herein. The filter media 60 can be constructed, for example, from nonwoven fibrous media formed of thermoplastics or thermosetting materials such as polypropylene, linear polyethylene and polyvinyl chloride. Other suitable, non-limiting materials for the filter media include porous foams, nonwovens, papers, fiberglass, or the like. The pleated filter media assembly 30 can optionally include a highly open wire mesh or screen, one or more adhesive strands, etc., bonded to the filter media 60 in order to enhance the pleatability thereof and that is pleated along with the filter media 60 itself.

In some embodiments, the filter media 60 comprises a nonwoven web that can have random fiber arrangement and generally isotropic in-plane physical properties (e.g., tensile strength), or if desired may have aligned fiber construction (e.g., one in which the fibers are aligned in the machine direction as described in U.S. Pat. No. 6,858,297 to Shah et al., the teachings of which are incorporated herein by reference) and anisotropic in-plane physical properties. Some or all of the fibers comprising the nonwoven webs useful with the filter media 60 can be multicomponent fibers having at least a first region and a second region, where the first region has a melting temperature lower than the second region. Some suitable multicomponent fibers are described, for example, in U.S. Pat. Nos. 7,695,660, 6,057,256, 5,597,645, 5,972,808, 5,662,728 and 5,486,410 the teachings of each of which are incorporated herein by reference in their entireties.

Other nonwoven webs useful with the filter media 60 can be a high loft spunbond web, such as described, for example, in U.S. Pat. No. 8,162,153 to Fox et al., the entire teachings of which are incorporated herein by reference. In other embodiments, the filter media 60 can be a low loft spunbond web, such as those described in U.S. Pat. No. 7,947,142 to Fox et al., the entire teachings of which are incorporated herein by reference. In yet other embodiments, nonwoven webs useful with the filter media 60 are generated by other techniques and/or have other characteristics, such as the meltblown nonwoven webs disclosed in U.S. Pat. No. 6,858,297 to Shah et al. (mentioned above). Other non-limiting example of useful nonwoven web formats include bi-modal fiber diameter meltblown media such as that described in U.S. Pat. No. 7,858,163, the entire teaching of which are incorporated herein by reference.

In some embodiments, an electrostatic charge is optionally imparted into or on to material(s) of the filter media 60. Thus, the filter media 60 can be an electret nonwoven web. Electric charge can be imparted to the filter media 60 in a variety of ways as is well known in the art, for example by hydrocharging, corona charging, etc. (e.g., as described in U.S. Pat. No. 7,947,142 (mentioned above)). In other embodiments, the filter media 60 is not electrostatically charged.

Pleats can be formed in the filter media 60 (or in the pleated filter media assembly 30) using various methods and components as are well known in the art, e.g., to form a pleated filter for use in applications such as air filtration., for example those described in U.S. Pat. No. 6,740,137 to Kubokawa et al. and U.S. Pat. No. 7,622,063 to Sundet et al., the entire teachings of both of which are incorporated herein by reference.

Returning to FIGS. 1A-1C, the end frame members 32, 34 are each generally configured for mounting to a corresponding one of the ends 48a, 48b (best seen in FIG. 2A), respectively, of the pleated filter media assembly 30, and in some embodiments can be identical or substantially identical. The end frame members 32, 34 serve as handles, promoting user grasping and manipulation of the air filter 20, covering of the ends 48a, 48b of the pleated filter media assembly 30, and a more rigid structure for insertion into, and retention within, the filter receiving housing or bay provided with many residential HVAC systems. In some embodiments, the end frame members 32, 34 are constructed of a material commonly used for HVAC filter frames, such as paper, paperboard, plastic, metal, etc. The end frame members 32, 34 can each have a length that substantially corresponds with a dimension of the corresponding pleated filter assembly end 48a, 48b, although other dimensional relationships are envisioned. While each of the end frame members 32, 34 may encompass a small portion of each of the opposing sides 50a, 50b of the pleated filter media assembly 30, presence of the end frame members 32, 34 does not overtly restrict collapsing of the pleated filter media assembly 30. For example, at least a majority, and in some embodiments at least 70%, 80%, 90% or at least 95%, of a length of the opposing sides 50a, 50b are unencumbered by the end frame members 32, 34, allowing the pleated filter media assembly 30 to be condensed into a compact format in the collapsed state (e.g., at least a majority of the pleats 40 (FIG. 2B) of the pleated filter media assembly 30 are free of the end frame members 32, 34). The end frame members 32, 34 can be attached to the pleated filter media assembly 30 in various manners as known in the art and appropriate for the materials employed. For example, in some embodiments, the end frame members 32, 34 are adhesively bonded over a corresponding one of the ends 48a, 48b of the pleated filter media assembly 30.

The side frame members 36, 38 can assume a variety of forms, and in some embodiments are substantially identical. Each of the side frame member 36, 38 defines opposing, leading and trailing ends 70, 72 (identified for the first side frame member 36 in the views of FIGS. 1A-1C), with the trailing end 72 optionally being permanently connected to a corresponding one of the end frame members 32 at a hinge point 74. For example, the first side frame member 36 is pivotably attached to the first end frame member 32 proximate a corner defined by the first end 48a and the first side 50a, whereas the second side frame member 38 is pivotably attached to the second end frame member 34 proximate a corner defined by the second end 48b and the second side 50b. The hinged or pivoting connection can be provided in various manners as would be apparent to one of ordinary skill. For example, a pin, hinge, or other mechanical-type component can be included that connects the side frame member 36, 38 with the corresponding end frame member 32, 34. In other embodiments, the end frame member 32, 34 and the corresponding side frame member 36, 38 can be integrally formed as a homogenous body, with the hinge point 74 being established as a living hinge imparted or formed in the homogenous structure. The length of each of the side frame members 36, 38 can be less than, equal to or greater than the length of each of the end frame members 32, 34. Regardless, the side frame member 36, 38 can pivot or rotate relative to the corresponding end frame member 32, 34 as best reflected by FIG. 1B, and thus can be readily manipulated by a user (manually) from a first arrangement in the collapsed state (FIG. 1A) to a second arrangement in the expanded state (FIG. 1C). In some embodiments, the first arrangement entails the side frame members 36, 38 each being nested with or located in highly close proximity to the corresponding end frame member 32, 34 (e.g., in the collapsed state of FIG. 1A, the first side frame member 36 is disposed against the first end frame member 32). In some embodiments, the second arrangement entails the side frame members 36, 38 each engaged with at least portion of the filter media assembly 30 along the corresponding side 50a, 50b thereof as well as the opposing end frame member 32, 34 (e.g., in the expanded state of FIG. 1C, the second side frame member 38 is engaged with the filter media assembly 30 at the first side 50b (hidden in FIG. 1C), and the leading end 70 of the second side frame member 38 is engaged with the first end frame member 32).

The side frame members 36, 38 are, in some embodiments, identical or substantially identical, and can optionally incorporate various features that facilitate deployment in one or both of the first and second arrangements mentioned above. For example, and as identified for the second side frame member 38 in the view of FIG. 1B, an interior surface 80 of the side frame member 38 can include or be coated with, or have applied thereto by a user, an adhesive. As a point of reference, in the second arrangement (i.e., the expanded state) of the side frame members 36, 38, the interior surface 80 faces the pleated filter media assembly 30 whereas in the first arrangement (i.e., the collapsed state), interior surface 80 faces away from the pleated filter media assembly 30. The adhesive can be disposed at various locations along the interior surface 80, such as proximate the longitudinal edges of the side frame members 36, 38 and/or at a tab 82 optionally formed at the leading end 70. Further, a release liner (not shown) can be placed over the adhesive in the initial collapsed state that can be removed by a user when desired. Regardless, in the second arrangement, the side frame members 36, 38 can be manipulated (e.g., pinched or pressed) to bring the adhesive-bearing portion of the interior surface 80 into contact with the pleated filter media assembly 30 to secure the side frame member 36, 38 to the pleated filter media assembly 30. Similarly, the leading end 70 (e.g., the optional tab 82) can be pressed against the corresponding, opposing end frame member 32, 34 to secure the leading end 70 to the opposing end frame member (e.g., in the expanded state of FIG. 1C, the leading end 70 of the second side frame member 38 is secured to the first end frame member 32). To facilitate this pressing operation, the side frame members 36, 38 can be constructed of a relatively deformable or shapeable yet relatively structurally rigid material, such as paperboard, cardboard, thin plastic, etc., that can be pressed by a user's hand into contact with the pleated filter media assembly 30 and/or the opposing end frame member 32. Other materials such as metal, plastic, etc., are also envisioned. Engagement features, such as pins, teeth, hooks, etc., may be advantageously incorporated into the frame members to provide or promote attachment frame member to the pleated filter media assembly 30. Regardless of the selected material, the side frame members 36, 38 can be formed to a predetermined shape conducive to placement over the corresponding side 50a, 50b of the pleated filter media assembly 30, for example a U- or C-shape.

In some embodiments, the side frame members 36, 38 are sufficiently resilient or re-shapeable to form or nest against the end frame member 32, 34 to which it is pivotably attached in the first arrangement/collapsed state, and to be formed or nest against the pleated filter media assembly 30 in the second arrangement/expanded state (e.g., the side frame members 36, 38 can be formed of a paperboard or cardboard or similar material have fold lines imparted therein that promotes folding of opposing side edge segments 84a, 84b over the attached end frame member 32, 34 in the first arrangement/collapsed state, and then folding the opposing side edge segments in an opposite direction over the pleated filter media assembly 30 in the second arrangement/expanded state). In related embodiments, the side frame members 36, 38 are sufficiently deformable to be folded at any location along a length thereof in accordance with a selected length of the pleated filter media assembly 30 in the expanded state. Alternatively, the side frame member 36, 38 can have a more rigid construction defining a U- or C-shape, with the hinge point 74 permitting pivoting and twisting of the side frame member 36, 38 such that the interior surface 80 can be arranged to “face” inwardly in both the first and second arrangements. In yet other embodiments, the side frame members 36, 38 can be more rigid and do not provide a shape conducive to nesting over the corresponding end frame member 32, 34 in the first arrangement/collapsed state.

The air filter 20 is initially arranged in the collapsed state (FIG. 1A) in which the pleated filter media assembly 30 is condensed (and held) into a compact media pack. The air filter 20 can be shipped to a retailer, stored at the retailer's place of business, displayed on the retailer's shelves, transported by a purchaser/user, and/or temporarily stored by the user in the collapsed state. At each of the stages, the air filter 20 (in the collapsed state) beneficially occupies a significantly reduced volume (as compared to the expanded state), thereby reducing associated costs and increasing user satisfaction. In some embodiments, the air filter 20 can include additional components (e.g., outer packaging such as shrink wrap plastic) that “holds” the pleated filter media assembly 30 to the collapsed state (preventing the pleated filter media assembly 30 from self-expanding).

When the user is ready to install the air filter 20 to an HVAC system, the user simply pulls on the two end frame members 32, 34 to stretch the pleated filter media assembly 30 to a desired size corresponding with the filter receiving housing or bay of the HVAC system. As a point of reference, where the HVAC system's filter receiving bay is sized and shaped for use with a 20″ (width)×25″ (length)×1″ (depth) air filter, the air filter 20 can have a width on the order of 20″ and a depth on the order of 1″ in both the collapsed and expanded states, and can be arranged in the expanded state to have a length on the order of 25″. However, in the collapsed state, the air filter 20 will have a length much less than 25″ (e.g., less than 50% of the length in the expanded state). Once the air filter 20 has been stretched to the desired size (e.g., desired length), the side frame members 36, 38 are pivoted or rotated (as in FIG. 1B) over the corresponding side 50a, 50b of the pleated filter media assembly 30 and into contact therewith (as in FIG. 1C). Further, the side frame members 36, 38 are secured to the corresponding opposing end frame member 32, 34 as described above. In this regard, the side frame members 36, 38 can accommodate a plethora of different lengths effectuate by a user in the expanded state, simply forming around the selected length and into engagement with the corresponding opposing end frame member 32, 34. Once the side frame members 36, 38 are secured in the expanded state, the air filter 20 can be inserted into the HVAC system and will perform to filter contaminants from the HVAC system's airflow. The side frame members 36, 38 maintain their strength in the expanded state to ensure the integrity of the air filter 20, combining with the end frame members 32, 34 to collective define a frame that secures the pleated filter media assembly 30.

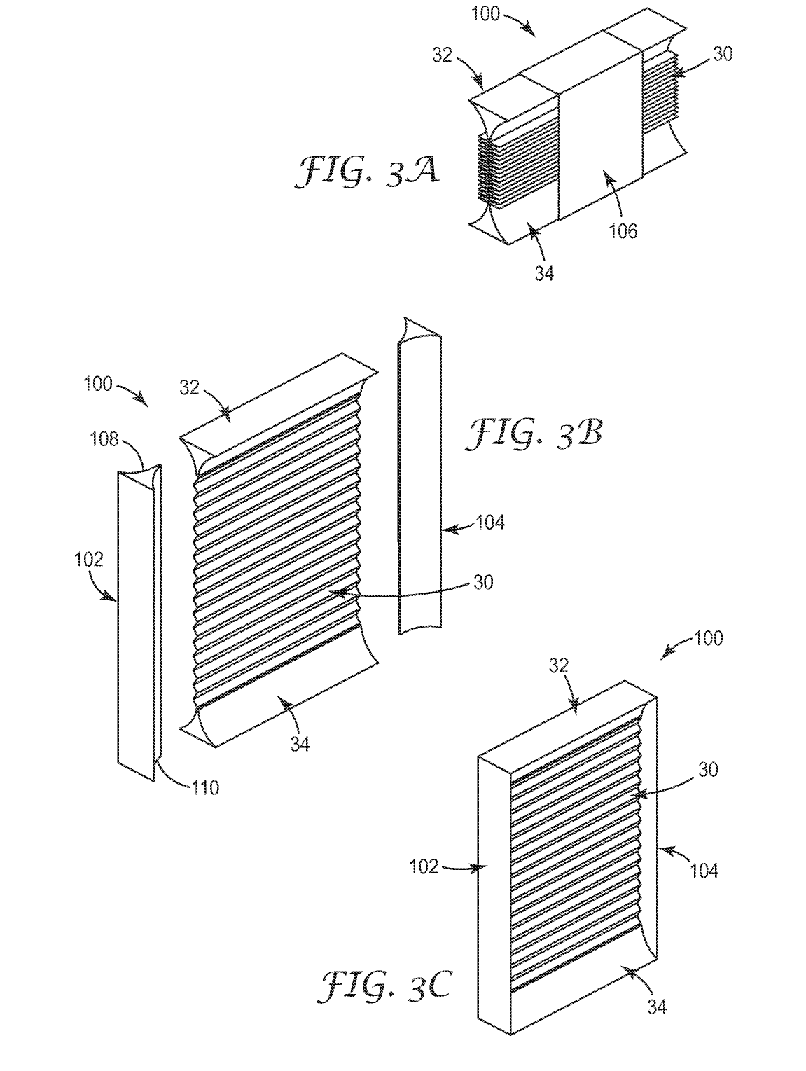

Another embodiment air filter 100 in accordance with principles of the present disclosure is shown in FIGS. 3A-3C. The air filter 100 is configured to be transitionable from, optionally between, a collapsed, initial state (FIG. 3A) to an expanded, end-use state (FIG. 3C), and to self-retain the expanded state for installation and use within an HVAC system. The air filter 100 is akin to the air filter 20 (FIGS. 1A-1C), and includes the pleated filter media assembly 30 and the opposing end frame members 32, 34 that can assume any of the forms described above. In addition, the air filter 100 includes first and second side frame members 102, 104. Optionally, removable packaging or wrapping 106 can be included that “holds” the air filter 20 in the collapsed state (as shown in FIG. 3A). Regardless, the side frame members 102, 104 can be identical or substantially identical, and are configured for assembly to the end frame members 32, 34. For example, and as identified for the first side frame member 102 in FIG. 3B, the side frame member 102 can defines opposing ends 108, 110 that are each configured coupling to a corresponding one of the end frame members 32, 34. For example, the end frame members 32, 34 can form apertures sized and shaped to receive (e.g., frictionally receive) one of the ends 108, 110. The end frame members 32, 34 and the side frame members 102, 104 can incorporate a wide variety of other complementary structures, components, and/or mechanisms that promote mounted engagement as are readily apparent to one of ordinary skill.

In some embodiments, the side frame members 102, 104 are further configured to have an adjustable length. For example, the side frame members 102, 104 can each include two (or more) components or bodies that are slidable relative to one another in a telescoping-like fashion. Alternatively, the side frame members 102, 104 can include or incorporate a wide variety of other structures, components and/or mechanisms that allow a user to adjust and select a length of the side frame member 102, 104. In yet other embodiments, the side frame members 102, 104 have a pre-determined, unchanging length.

The air filter 100 can initially be in the collapsed state (and thus has a compact volume) during shipping, storage, and/or on the retailer's shelves. The air filter 100 can optionally include additional component(s) (e.g., the packaging 106) that holds the air filter 100 in the collapsed state. When the user is ready to install the air filter 100 to an HVAC system, the user simply pulls on the two end frame members 32, 34 to stretch the pleated filter media assembly 30 to a desired length in the expanded state of FIG. 3B. The side frame members 102, 104 are then adjusted to a length corresponding with the length of the pleated filter media assembly 30 selected by the user. The so-adjusted side frame members 102, 104 are then mounted to the end frame members 32, 34 as described above to secure to the pleated filter media assembly 30 in the frame defined by the end frame members 32, 34 and the side frame members 102, 104. The air filter 100 is then installed to the HVAC system and functions to remove contaminants from the HVAC system airflow.

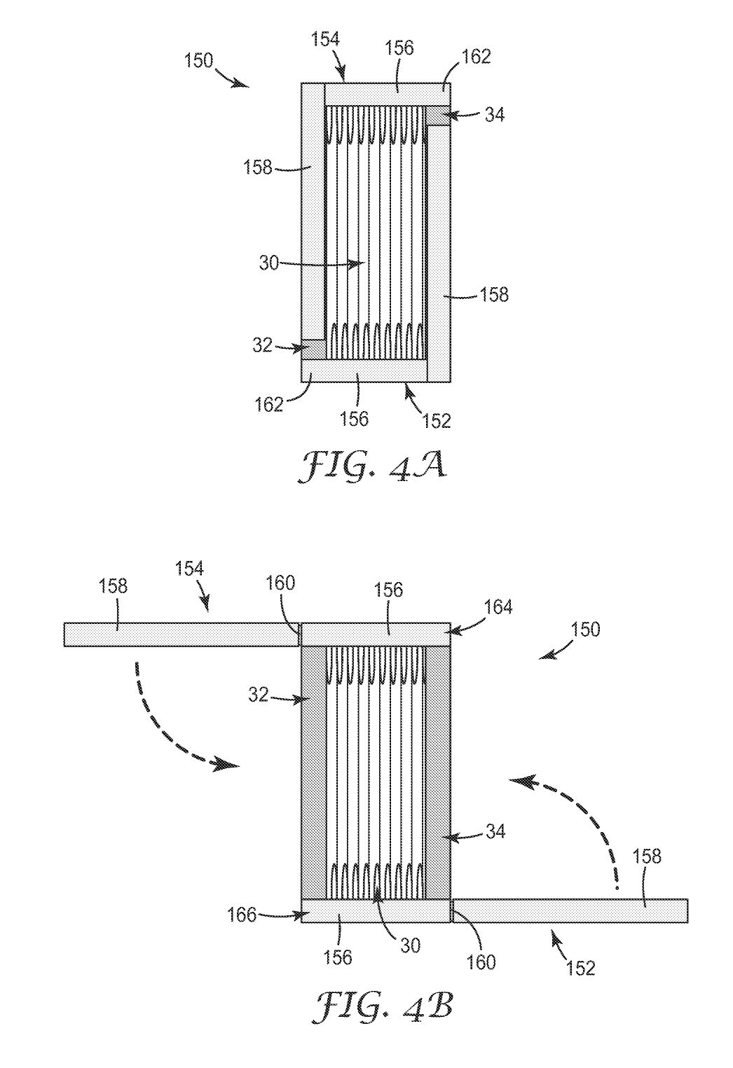

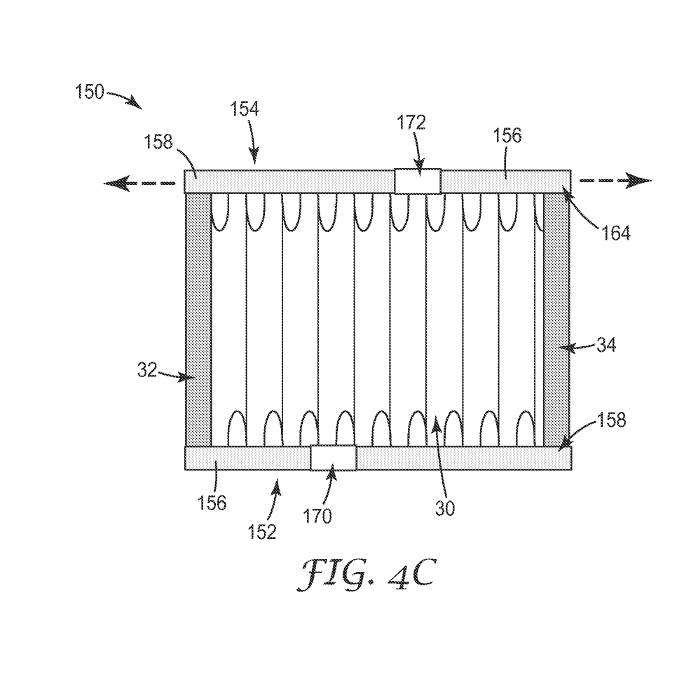

Another embodiment air filter 150 in accordance with principles of the present disclosure is shown in FIGS. 4A-4C. The air filter 150 is configured to be transitionable from, optionally between, a collapsed, initial state (FIG. 4A) to an expanded, end-use state (FIG. 4C), and to self-retain the expanded state for installation and use within an HVAC system. The air filter 150 is akin to the air filter 20 (FIGS. 1A-1C), and includes the pleated filter media assembly 30 and the opposing end frame members 32, 34 that can assume any of the forms described above. In addition, the air filter 150 includes first and second side frame members 152, 154. The side frame members 152, 154 can be identical or substantially identical, and each include or define a first section 156 and a second section 158. The first and second sections 156, 158 are pivotably coupled to one another at a hinge point 160 and can each have a U- or C-shape that defines a channel that can be received over an edge of the pleated filter media assembly 30. A trailing end 162 of the first section 156 is attached (e.g., bonded) to a corresponding one of the end frame members 32, 34 at a corner of the air filter 150 (e.g., FIGS. 4B and 4C identify that the first section 156 of the second side frame member 154 is attached to the second end frame member 34 at corner 164; FIG. 4B further identifies that the first side frame member 152 is attached to the first end frame member 32 at corner 166).

A length of the first section 156 (e.g., distance between the trailing end 162 and the corresponding hinge point 160) corresponds with a length of the pleated filter media assembly 30 in the collapsed state. Thus, in a first arrangement of the side frame members 152, 154 (i.e., the collapsed state of FIG. 4A), the corresponding second section 158 can be arranged over a corresponding opposite end frame member 32, 34 (e.g., in FIG. 4A, the second section 158 of the first side frame member 152 is located over the second end frame member 34). The second section 158 can be rotated or pivoted relative to the corresponding first section 156 away from the corresponding opposite end frame member 32, 34 (e.g., in FIG. 4B, the second section 158 of the first side frame member 152 has been pivoted away second end frame member 34). Finally, the second section 158 can be disposed over, and optionally secured to, the corresponding side 50a, 50b of the pleated filter media assembly 30 (e.g., in FIG. 4C, the second section 158 of the first end frame member 152 is located over the first end 50a (hidden in FIG. 4C, but shown, for example, in FIG. 2A) of the pleated filter media assembly 30. In some embodiments, the second section 158 can carry or be coated with an adhesive for securing the second section to one or both of the pleated filter media assembly 30 and the corresponding opposing end frame member 32, 34 when located in the second arrangement of FIG. 4C. In yet other embodiments, the air filter 150 optionally includes first and second coupling bodies 170, 172 as shown in FIG. 4C (e.g., clasps, covers, etc.) that can be applied over a corresponding one of the hinge points 160 in the expanded state.

The air filter 150 can initially be in the collapsed state (and thus has a compact volume) during shipping, storage, and/or on the retailer's shelves. The air filter 150 can optionally include additional components (e.g., packaging) that holds the air filter 150 in the collapsed state. When the user is ready to install the air filter 150 to an HVAC system, the user simply unfolds the second section 158 of the first and second side frame members 152, 154 (e.g., as in FIG. 4B) and then second pulls on the two end frame members 32, 34 to stretch the pleated filter media assembly 30. In this regard, the pleated filter media assembly 30 readily slides within channel shape of the second sections 158. Once in the expanded state in which the second sections 158 are aligned with the corresponding, opposite end frame member 32, 34, each of the second sections 158 are coupled (e.g., adhesively bonded) to the corresponding, opposite end frame member 32, 34 to securely fasten the pleated filter media assembly 30 within the frame collectively formed by the end frame members 32, 34 and the side frame members 152, 154. The air filter 150 is then installed to the HVAC system and functions to remove contaminants from the HVAC system airflow.

Example air filters in accordance with the above descriptions of the air filter 150 were prepared using channel-shaped frame members and a wire-backed pleated filter media assembly providing a 1 pleat per inch density when fully expanded. The example air filters exhibited about 2/3 compression in the collapsed state (i.e., the example air filter had a length of 25 inches in the expanded state and a length of 8 inches in the collapsed state).

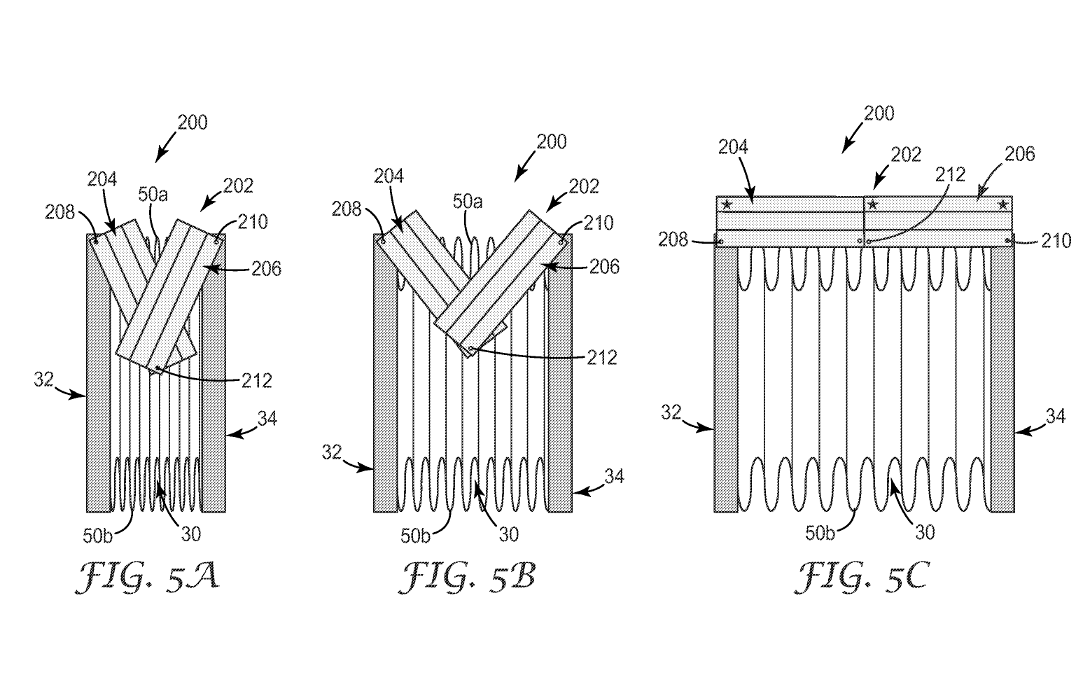

Another embodiment air filter 200 in accordance with principles of the present disclosure is shown in FIGS. 5A-5C. The air filter 200 is configured to be transitionable from, optionally between, a collapsed, initial state (FIG. 5A) to an expanded, end-use state (FIG. 5C), and to self-retain the expanded state for installation and use within an HVAC system. The air filter 200 is akin to the air filter 20 (FIGS. 1A-1C), and includes the pleated filter media assembly 30 and the opposing end frame members 32, 34 that can assume any of the forms described above. In addition, the air filter 200 includes first and second side frame members 202. As a point of reference, only one of the side frame members 202 is shown in FIGS. 5A-5C for ease illustration and assembled adjacent the first side 50a of the pleated filter media assembly 30; the second side frame member can be identical to the side frame member 202 shown, and is assembled adjacent the second side 50b. Each of the side frame members 202 includes first and second sections 204, 206. As a point of reference, a portion of the second section 206 is drawn transparent in the views to better illustrate the first section 204). The first and second sections 204, 206 can be identical or substantially identical, and can be formed of a rigid or semi-rigid material (e.g., paperboard, cardboard, plastic, metal, etc.). In some embodiments, the sections 204, 206 can be shaped by a user to define a channel (it being understood that in the views of FIGS. 5A-5C, the sections 204, 206 are shown in flattened form). Regardless, the first section 204 is pivotably coupled to the first end frame member 32 at a first pivot point 208, the second section 206 is pivotably coupled to the second end frame member 34 at a second pivot point 210, and the first and second sections 204, 206 are pivotably coupled to one another at a third pivot point 212 that is located opposite the first and second pivot points 208, 210. A scissors-type relationship is thus established in some embodiments. The pivotable couplings can be provided in a wide variety of manners as will be apparent to one of ordinary skill (e.g., a rotatable connecting member such as a rivet, pin, brad, etc.). In some embodiments, the first and second sections 204, 206 can optionally be coated with or carry an adhesive as described below.

In a first arrangement of the side frame members 202 (corresponding with the collapsed state of FIG. 5A), the sections 204, 206 are pivoted relative to one another to an overlapping relationship. In a second arrangement of the side frame members 202 (corresponding with the expanded state of FIG. 5C), the sections 204, 206 are pivoted relative to one another to a non-overlapping relationship.

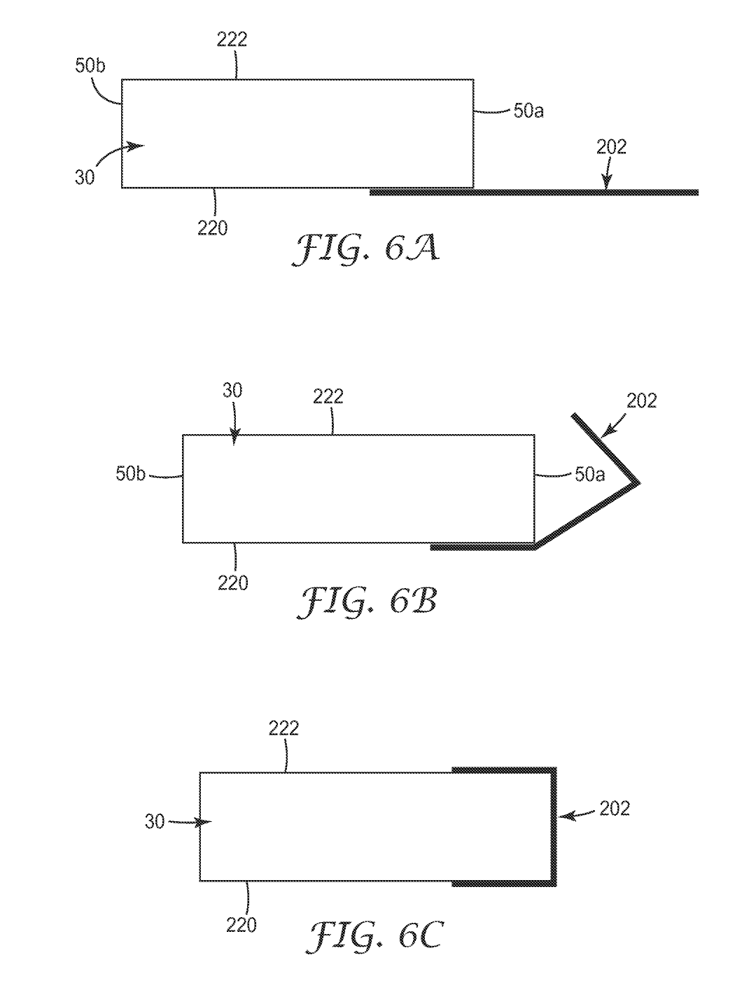

The air filter 200 can initially be in the collapsed state (and thus has a compact volume) during shipping, storage, and/or on the retailer's shelves. The air filter 200 can optionally include additional components (e.g., packaging) that holds the air filter 200 in the collapsed state. When the user is ready to install the air filter 200 to an HVAC system, the user simply pulls on the two end frame members 32, 34 to stretch the pleated filter media assembly 30. The side frame members 202 readily articulate or expand in conjunction with stretching of the pleated filter media assembly, as reflected by a progression from FIG. 5A to FIG. 5C. When the pleated filter media assembly 30 is fully extended, each of the side frame members 202 effectively run in a straight line (e.g., the corresponding sections 204, 206 are linearly aligned with one another). The side frame members 202 can optionally be configured for more robust connection to the pleated filter media assembly 30 in the expanded state. For example, and as shown in FIG. 6A, the side frame member 202 is connected to a first major face 220 of the pleated filter media assembly 30 and initially projects away from the pleated filter media assembly 30. The side frame member 202 is then wrapped around the corresponding side 50a, 50b of the pleated filter media assembly 30 and onto the opposite major face 222 (FIG. 6C) to form a U-shaped channel frame. With additional reference to FIGS. 5A-5C, where the two sections 204, 206 of each side frame member 202 overlap, adhesive strips (not shown) or other bonding means can be employed to attach the sections 204, 206. Similarly, at points of contact between the end frame members 32, 34 and the side frame members 202, adhesive strips (not shown) or other bonding means can be employed to attach the frame members 32, 34, 202. In yet other embodiments, the side frame members 202 optionally carry an adhesive that bonds to the major face(s) 220, 222 of the pleated filter media assembly. Regardless, in the expanded state, the pleated filter media assembly 30 is robustly supported by the frame effectively defined by the frame members 32, 34, 202. The air filter 200 is then installed to the HVAC system and functions to remove contaminants from the HVAC system airflow, and can later be discarded as described above.

The air filter of FIGS. 5A-5C are one-piece air filters. As used herein, the term “one-piece frame” refers to an air filter assembly that is capable of forming a complete 4-sided frame but may include more than 1 piece as long as all pieces of the frame are connected and/or form a single system.

The air filters of the present disclosure provide a marked improvement over previous designs. The air filters can be collapsed to save shelf-space and transportation space. The collapsed filter can be easily expanded and assembled to its usable form, making it easy for end-users to use the air filter.

Although specific embodiments of the present disclosure have been shown and described herein, it is understood that these embodiments are merely illustrative of the many possible specific arrangements that can be devised in application of the principles of the present disclosure. Numerous and varied other arrangements can be devised in accordance with these principles by those of ordinary skill in the art without departing from the spirit and scope of the present disclosure. Thus, the scope of the present disclosure should not be limited to the structures described in this application, but only by the structures described by the language of the claims and the equivalents of those structures.

What is claimed is:

1. An HVAC air filter, comprising:
a frame having first and second end frame members and first and second side frame members; and
filter media extending between and attached to the first and second end frame members or the first and second side frame members but not attached to the other of the first and second end frame members or the first and second side frame members;
wherein the frame is a two-piece frame that is attached to the filter media.

2. The HVAC air filter of claim 1, wherein the filter media includes pleats.

3. The HVAC air filter of claim 1,
wherein first and second side frame members are respectively coupled to the first and second end frame members to form the two-piece frame.

4. The HVAC air filter of claim 3, wherein the first and second side frame members are respectively coupled to the first and second end frame members via a hinge.

5. The HVAC air filter of claim 1,
wherein the air filter is configured to provide a collapsed state in which the filter media is compacted, and an expanded state in which the filter media is stretched, a distance between the first and second end frame members in the collapsed state is less than the length between the first and second end frame members in the expanded state.

6. The HVAC air filter of claim 1, wherein the side frame members are transitionable to an arrangement that retains the air filter in the expanded state.

7. The HVAC air filter of claim 1 further comprising:
a closure.

8. The HVAC air filter of claim 1, further comprising:
one or more components or bodies that are slidable relative to one another in a telescoping-like fashion and that can be attached to at least one of (1) the first or second end frame members or (2) the first or second side frame members.

9. The HVAC air filter of claim 1, wherein at least one of the first and second side frame members can be attached to the filter media.

10. An HVAC air filter, comprising:
a frame having first and second end frame members and first and second side frame members; and
filter media extending between and attached to the first and second end frame members or the first and second side frame members but not attached to the other of the first and second end frame members or the first and second side frame members;
wherein the frame is a one-piece frame at least a portion of which is attached to the filter media.

11. The HVAC air filter of claim 10, wherein the filter media includes pleats.

12. The HVAC air filter of claim 10, wherein
the filter media includes opposing sides and opposing ends, and
first and second end frame members are assembled to a corresponding one of the opposing ends;
wherein first and second side frame members are selectively coupled to the end frame members and over a respective one of the opposing sides.

13. The HVAC air filter of claim 10, wherein the air filter is configured to provide a collapsed state in which the pleats are compacted, and an expanded state in which the pleats are stretched, the length in the collapsed state is less than the length in the expanded state.

14. The HVAC air filter of claim 10, further comprising:
wherein the side frame members are transitionable to an arrangement that retains the air filter in the expanded state

15. The HVAC air filter of claim 10, further comprising:
a first section pivotably coupled to the first frame end member at a first pivot point;
a second section pivotably coupled to the second end frame member at a second pivot point; and
the first and second sections pivotably coupled to each other at a third pivot point.

16. An HVAC air filter comprising:
a pleated filter medium assembly defining pleats, opposing sides and opposing ends;
first and second end frame members assembled to a corresponding one of the opposing ends; and
first and second side frame members selectively coupled to the end frame members and over a respective one of the opposing sides;
wherein a distance between the end members define a length of the air filter;
and further wherein the air filter is configured to provide a collapsed state in which the pleats of the pleated filter medium assembly are compacted, and an expanded state in which the pleats are stretched, the length in the collapsed state being less than the length in the expanded state, the side frame members being transitionable to an arrangement that retains the air filter in the expanded state.
